(19) United States
(12) Patent Application Publication
(10) Pub. No.: US 2014/0013777 A1
(43) Pub. Date: Jan. 16, 2014

(54) STORAGE TANK HAVING HEAT EXCHANGER AND NATURAL GAS FUEL SUPPLY SYSTEM HAVING SAME STORAGE TANK

(71) Applicant: JUNG-WOO ENE CO., LTD., Busan (KR)

(72) Inventor: Lee Sun-hae, Busan (KR)

(73) Assignee: JUNG-WOO ENE CO., LTD., Busan (KR)

(21) Appl. No.: 14/025,936

(22) Filed: Sep. 13, 2013

Related U.S. Application Data
(63) Continuation of application No. PCT/KR2011/003659, filed on May 17, 2011.

(30) Foreign Application Priority Data
May 4, 2011 (KR) 10-2011-0042681

(51) Int. Cl. F17C 5/02

(52) U.S. Cl. CPC F17C 5/02
USPC 62/49.1; 62/50.2

(57) ABSTRACT

The present invention relates to a storage tank having a heat exchanger and a natural gas fuel supply system having the storage tank. The storage tank having a heat exchanger according to one aspect of the present invention includes: a heat exchanger installed in an upper portion of an inside space of the storage tank, wherein the heat exchanger includes: an expansion valve into which LNG, which is highly pressurized by a pressurizer, is introduced; and a heat exchanger pipe which guides a flow of the LNG so that the LNG expands in the heat exchanger.

### REFERENCE TO RELATED APPLICATIONS

This is a continuation of pending International Patent Application PCT/KR2011/003659 filed on May 17, 2011, which designates the United States and claims priority of Korean Patent Application No. 10-2011-0042681 filed on May 4, 2011, the entire contents of which are incorporated herein by reference.

### FIELD OF THE INVENTION

The present invention relates to a storage tank having a heat exchanger and a natural gas fuel supply system having the storage tank, and more particularly to a storage tank having a heat exchanger which can reliquefy Boiled Off Gas (BOG) in the storage tank and a natural gas fuel supply system having the storage tank.

### BACKGROUND OF THE INVENTION

Generally, in a Liquefied Natural Gas (LNG) carrier and a gasification facility which uses LNG in a terminal as fuel, in order to generate driving force or electricity power, low temperature Natural Boiled Off Gas (NBOG) which naturally occurs in a cargo containment system and low temperature Forced Boiled Off Gas (FBOG) obtained through forced gasification using a heat exchanger are used as fuel for operating an engine or a boiler.

For transportation of the maximum amount of LNG at a time, LNG is stored and transported in a liquid phase. The LNG is usually stored as a cryogenic liquid in a storage tank. For use of this LNG, the LNG is first compressed by a high pressure pump and then gasified by a gasifier. The gasified LNG is heated by a gas heater and turns into gas. This gas maintaining a constant temperature and high pressure is supplied to a consumer through a pipe line.

LNG naturally evaporates even though it is stored in well-controlled cryogenic conditions, so that the internal pressure of a storage tank increases. This increases the pressing force applied to the internal wall of the storage tank and thus the risk of explosion of the storage tank increases.

Accordingly, in order to prevent gas discharged to the air via a safety valve from increasing in amount and from lingering in the air for a long time or to prevent the pressure of gas in a storage tank from reaching an excessively high level due to increase in amount of BOG in the storage tank during a long period of storage, a system for liquefying gasified gas is necessary.

However, natural gas fuel supply systems according to conventional technologies are not equipped with such a system so that they cannot reliquefy BOG. Although there are some systems that can reliquefy BOG, it is necessary to circulate an excessively large amount of LNG for only a small amount of BOG to be liquefied. Additionally, the heat exchange process consumes a great deal of power.

Furthermore, conventional natural gas fuel supply systems cannot store reliquefied BOG in the storage tank so that the reliquefied BOG has to be forcedly consumed or wasted.

### SUMMARY OF THE INVENTION

Accordingly, the present invention has been made keeping in mind the above problems occurring in the related art, and is intended to provide a storage tank having a heat exchanger and a natural fuel supply system having the storage tank which can liquefy BOG, which is naturally occurring in a storage tank containing natural gas, in the storage tank using the heat exchanger equipped within the storage tank. The invention has an advantage of not having to install additional auxiliary facilities such as pipes and vessels for liquefaction of the BOG.

Another object of the invention is to provide a storage tank having a heat exchanger and a natural gas fuel supply system having the storage tank which is environment-friendly by using liquefied natural gas in the storage tank as a coolant, without having to use an additional coolant.

A further object of the invention is provide a storage tank having a heat exchanger and a natural gas fuel supply system having the storage tank which has increased reliquefaction efficiency by having an increased surface contact area and which thus effectively reliquefies BOG.

In order to accomplish the objects of the invention, in one aspect of the present invention, a storage tank having a heat exchanger includes a heat exchanger which is provided in an upper portion of an inside space of a storage tank and which is equipped with an expansion valve into which LNG, which is highly pressurized by a pressurizer, is introduced, and a heat exchanger pipe which guides a flow of the LNG so that the LNG will expand inside the heat exchanger.

In another aspect of the present invention, a natural gas fuel supply system includes a storage tank which contains LNG and BOG existing above the LNG and which is equipped with a heat exchanger installed in an upper portion of an inside space of the storage tank, a pump which is connected to a portion of the storage tank in order to discharge the LNG stored in the storage tank, and a pressurizer which is connected to an outlet of the pump in order to increases pressure of the LNG transported by the pump.

According to a further aspect, a natural gas fuel supply system includes a storage tank which stores LNG and BOG existing above the LNG and which is equipped with a heat exchanger installed in an upper portion of an inside space of the storage tank, and a pressurizer which is connected to an outlet of the storage tank and increases pressure of the LNG transported, wherein the heat exchanger includes an expansion valve into which the LNG highly pressurized by the pressurizer is introduced and a heat exchanger pipe which guides a flow of the LNG so that the LNG will expand inside the heat exchanger.

The present invention has the following advantages.

The present invention relates to a technology which can reliquefy NBOG and FBOG in a storage tank and is used for a ship using LNG as fuel or a gasification facility using natural gas in a terminal as fuel. The present invention reduces the risk of explosion of the storage tank by adjusting an internal pressure of the storage tank and enables reliquefaction without having to use additional vessels and/or pipes.

Furthermore, the present invention reduces operating costs of the natural gas fuel supply system by performing effective heat exchanging in the storage tank.

Yet furthermore, the present invention is environment-friendly and reduces operating costs by allowing use of general coolants.

### BRIEF DESCRIPTION OF THE DRAWINGS

FIG. 1 is a diagram for describing a storage tank having a heat exchanger according to one embodiment of the present invention and a natural gas fuel supply system having the storage tank.

FIG. 2 is a diagram illustrating a storage tank having a heat exchanger according to another embodiment of the present invention and a natural gas fuel supply system having the storage tank.

### DETAILED DESCRIPTION OF THE INVENTION

A storage tank according to the best mode of the present invention is a storage tank for storing LNG. The storage tank is equipped with a heat exchanger in an upper portion of an inside space thereof. The heat exchanger includes an expansion valve, into which LNG, which is highly pressurized by a pressurizer, is introduced and a heat exchanger pipe which guides the flow of the LNG so that the LNG will expand in the heat exchanger.

A natural gas fuel supply system according to the best mode of the present invention includes a storage tank which contains LNG and BOG existing above the LNG and is equipped with a heat exchanger installed in an upper portion of an inside space thereof, a pump which is connected to a portion of the storage tank in order to discharge the LNG stored in the storage tank, and a pressurizer which is connected to an outlet of the pump in order to increase pressure of the LNG transported by the pump.

Preferably, the heat exchanger may include an expansion valve into which the LNG, which is highly pressurized by the pressurizer, is introduced and a heat exchanger pipe which guides a flow of the LNG so that the LNG will expand in the heat exchanger.

A natural gas fuel supply system according to another best mode of the present invention includes a storage tank which contains LNG and BOG existing above the LNG and is equipped with a heat exchanger installed in an upper portion of an inside space thereof, and a pressurizer which is connected to an outlet of the storage tank and increases pressure of the LNG transported, wherein the heat exchanger includes an expansion valve into which the LNG, which is highly pressurized by the pressurizer, is introduced and a heat exchanger pipe which guides a flow of the LNG so that the LNG will expand in the heat exchanger.

Preferably, the natural gas fuel supply system further includes a pressure gauge installed on a pipe through which gasified LNG, which is generated during heat exchanging in the heat exchanger, flows, a control valve installed on a pipe near an outlet of the pressurizer, wherein opening of the control valve is adjusted according to pressure measured by the pressure gauge.

Features and advantages of the present invention, and methods for achieving those become apparent with reference to embodiments described below and the accompanying drawings. The present invention is not limited to the following embodiments described below but may be embodied in various forms. The embodiments are presented to make complete disclosure of the present invention and help those who are ordinarily skilled in the art understand the field of the invention. Accordingly, the present invention is defined only by a description of the appended claims. The terms used in this specification are selected to describe embodiments and thus should not be interpreted to limit the present invention. An element expressed in a singular form in this specification may be plural elements. Embodiments of the present invention are described below with reference to the accompanying drawings.

As mentioned above, LNG is stored as liquid in a storage tank and naturally evaporates even though it is stored in well-controlled cryogenic conditions. This evaporation leads to an increase in internal pressure which pushes the internal wall of the storage tank, so that the risk of explosion of the storage increases.

A storage tank having a heat exchanger according to one embodiment of the present invention, and a natural gas fuel supply system having the storage tank is configured such that a heat exchanger 400 is installed inside a storage tank 500 in order to prevent an internal pressure in an LNG tank from excessively increasing. That is, the present invention provides a technology which forcibly liquefies gasified BOG 502 using the heat exchanger 400.

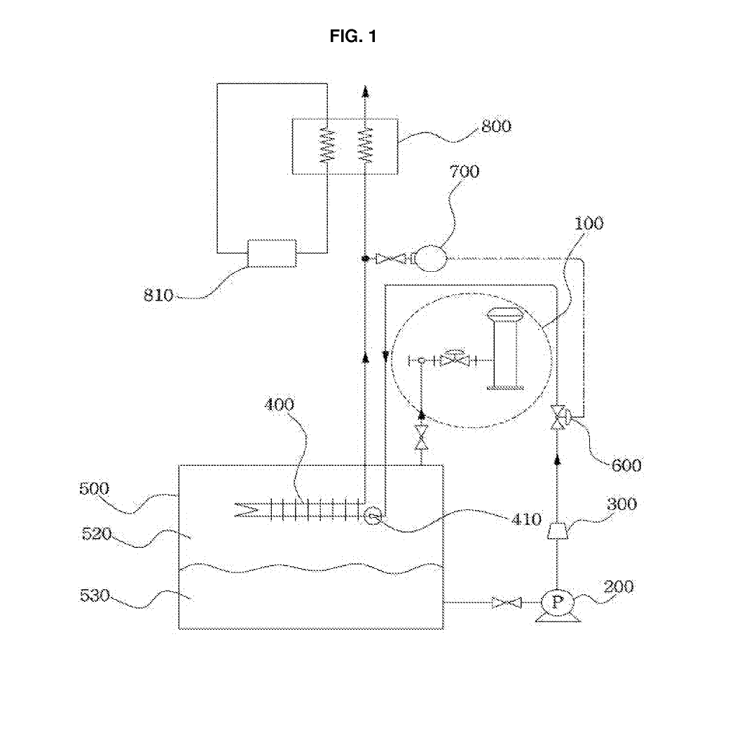

Herein below, a storage tank having a heat exchanger according to one embodiment of the present invention and a natural gas fuel supply system having the storage tank are described with reference to FIG. 1.

FIG. 1 is a diagram illustrating the storage tank having the heat exchanger and the natural gas fuel supply system having the storage tank according to the present invention.

With reference to FIG. 1, the storage tank 500 containing LNG therein is equipped with the heat exchanger 400 installed in an upper portion of an inside space thereof. The heat exchanger 400 includes an expansion valve 410 into which LNG, which is highly pressurized by a pressurizer 300, is introduced, and a heat exchanger pipe which guides a flow of the LNG so that the LNG will expand in the heat exchanger 400.

The storage tank 500 may be further equipped with a cooling fin or a cooling plate installed around the heat exchanger pipe in order to increase a surface contact area for heat exchanging with BOG.

The natural gas fuel supply system having a storage tank 500 includes the storage tank 500 having a heat exchanger 400 in an upper portion of an inside space thereof and containing LNG 530 and BOG 520 existing above the LNG 530, a pump 200 connected to a portion of the storage tank 500 in order to discharge the LNG in the storage tank 500, and a pressurizer 300 connected to an outlet of the pump 200 in order to increase pressure of the LNG transported by the pump 200.

The heat exchanger 400 may include an expansion valve 410 into which the LNG highly pressurized by the pressurizer 300 is introduced, and a heat exchanger pipe which guides a flow of the LNG so that the LNG will expand in the heat exchanger 400.

The heat exchanger 400 may be further equipped with a cooling fin or a cooling plate installed around the pipe in order to increase a surface area for heat exchanging with BOG.

Herein below, operation of the storage tank having the heat exchanger and the natural gas fuel supply system having the storage tank according to the above embodiments will be described.

The LNG 530 may be stored in the storage tank 500 according to the embodiment illustrated in FIG. 1 and the BOG 520 may also be stored above the LNG 530 in the storage tank 500.

A pipe and valve are connected to an end portion of the storage tank 500 in order to discharge the LNG 530 outside the storage tank 500. The pump 200 is connected to an opposed end portion of the storage tank 500 in order to pump and pressurize the LNG.

The pressurizer 300 is connected to the outlet of the pump 200 in order to further pressurize the LNG transported by the pump 200.

The LNG having a high pressure flows through the control valve 600 and returns to the storage tank 500 after passing through the pressurizer 300, and then undergoes expansion in the heat exchanger 400 which ranges from a position where the expansion valve 410 is installed.

The LNG is lowered in pressure through the expansion and undergoes phase change to gas due to evaporation heat lingering around the heat exchanger. This is called Joule Thomson effect.

That is, when high pressure fluid rapidly passes through an expansion valve, the fluid undergoes phase change to a gas while absorbing a great amount of evaporation heat, so that surrounding heat is reduced by this Joule Thomson effect.

The most important feature of the storage tank having a heat exchanger and the natural gas fuel supply system having the storage tank according to the above embodiments is that the heat exchanger is installed inside the storage tank in order to use the Joule Thomson effect. That is, the present invention is based on the idea that energy of the gaseous BOG 520, which may cause a risk of explosion of the storage tank 500 by applying strong force to the internal wall of the storage tank 500, is used as evaporation heat for the LNG which changes from a liquid phase to a gaseous phase while flowing at low pressure and high speed through the heat exchanger 400.

When a plurality of cooling pins or cooling plates are installed outside the heat exchanger 400, higher heat exchanging efficiency can be obtained.

Although the BOG 520 in the storage tank remains gaseous, the internal pressure of the storage tank is high and the internal temperature of the storage is just slightly higher than a boiling point under that pressure. Accordingly, the BOG 520 may easily condense in the heat exchanger 400 and then falls to a lower storage portion for the LNG 530 in the storage tank after the condensation.

The LNG enters a gasified state or a saturated liquid state (called gasified natural gas) in the heat exchanger 400, and moves to a heater 800.

The heater 800 gives heat energy, supplied from a heat source 810, to the gasified natural gas having a low temperature, and the gasified natural gas supplied with the heat energy enters a high temperature and high pressure state and moves to a consuming site.

A pressure gauge 700 measures pressure of the gasified natural gas moving to the heater 800 from the heat exchanger 400, and the control valve 600 may be controlled based on a pressure signal which is measured.

For example, when the pressure signal indicating a high pressure is being transmitted, the opening of the control valve 600 is decreased by a predetermined degree. Conversely the pressure signal indicating a low pressure is being transmitted, the opening of the control valve 600 is increased by a predetermined degree. In this way, the amount of the LNG supplied to the heat exchanger 400 can be adjusted.

According to the storage tank having a heat exchanger according to the above embodiment, since heat exchanging between the LNG (heat source to be cooled) flowing inside the pipe of the heat exchanger 400 and the BOG 520 existing outside the pipe is performed through the cooling pins having a large surface contact area, the BOG can be effectively reliquefied.

A BOG discharger 100 can discharge the BOG to the atmosphere. Specifically, the BOG discharger 100 discharges the BOG outside the storage tank or discharges gas via a safety valve when the pressure of the BOG is excessively high.

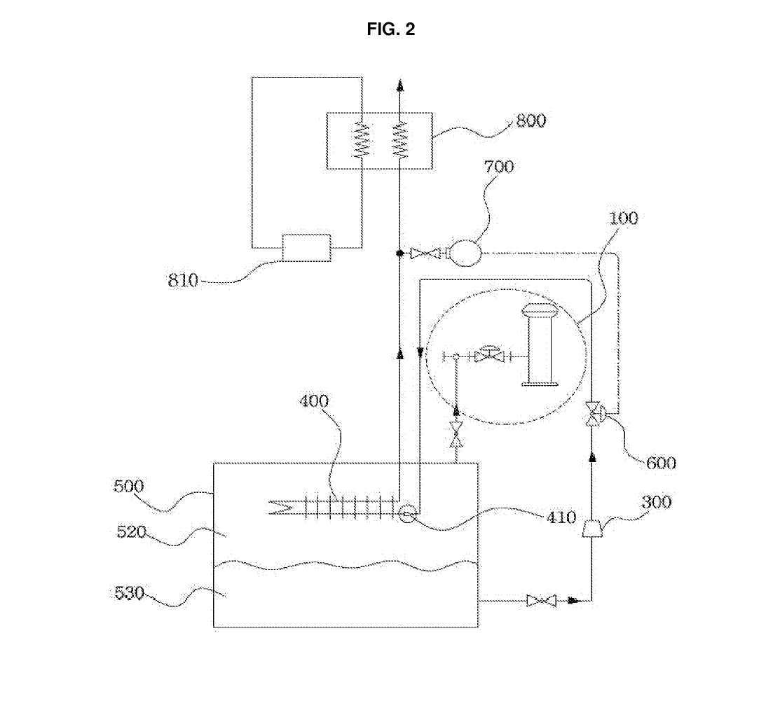

FIG. 2 is a diagram for describing a storage tank having a heat exchanger according to another embodiment of the present invention and a natural gas fuel supply system having the storage tank. It differs from those of FIG. 1 in that it is unnecessary to use a pump and a pressurizer 300 is directly connected to a storage tank 500.

The structure of the other parts is the same as that of FIG. 1. Therefore, a description about the other parts is omitted.

Herein below, the features of the storage tank having a heat exchanger and the natural gas fuel supply system having the storage tank according to the embodiments of the present invention are summarized as follows.

First, the storage tank having a heat exchanger according to one embodiment of the present invention and a natural gas fuel supply system having the storage tank relate to a technology which can reliquefy natural BOG and forced BOG. This technology can be used in a ship which uses LNG as fuel or a gasification facility which uses natural gas in a terminal. This technology can also be used for C.LNG stations in which natural gas is stored and used in a high pressure gaseous state. This technology is advantageous in that a risk of explosion of the storage tank is prevented because an internal pressure of the storage tank is adjusted and in that it is unnecessary to install additional vessels and pipes for the reliquefaction of fuel. Here, the C.LNG station means a station where LNG is stored and charged into vehicles in a liquid state, or charged into vehicles and devices using LNG as fuel in a compressed gaseous state.

Second, the storage tank having a heat exchanger according to the embodiment of the present invention and the natural gas fuel supply system having the storage tank have the advantage of reducing operating costs of the natural gas fuel supply system by performing effective heat exchanging in the storage tank.

Third, the storage tank having a heat exchanger according to the embodiment of the present invention and the natural gas fuel supply system having the storage tank have the advantages of being environment-friendly and reducing costs of materials by allowing use of general coolants, and also have the advantage of allowing for effective BOG reliquefaction using a simple structure.

Those skilled in the art will appreciate that the present invention can be embodied in different forms without changing the technical spirit or essential features of the present invention. Accordingly, it should be understood that the embodiments described above have been disclosed for illustrative purposes and do not limit the present invention. The scope of the present invention would be defined by the description of claims described below rather than the description of embodiments described above, and various modifications, changes, and alterations derived from the scope of the claims and equivalents thereof may fall within the scope of the present invention.

As described above, the storage tank having a heat exchanger and a natural gas fuel supply system having the storage tank according to the present invention relate to a technology which can reliquefy natural BOG in the storage tank and used for a ship using LNG as fuel or a gasification facility using natural gas in a terminal as fuel. The storage tank having a heat exchanger and the natural gas fuel supply system having the storage tank according to the present invention prevents a rise of explosion of the storage tank by adjusting the internal pressure of the storage tank and is not necessary to be equipped with additional vessels or pipes for reliquefaction of fuel.

What is claimed is:

1. A storage tank having a heat exchanger comprising:
a heat exchanger installed in an upper portion of an inside space of the storage tank, wherein
the heat exchanger includes:
an expansion valve into which LNG, which is highly pressurized by a pressurizer, is introduced; and
a heat exchanger pipe which guides a flow of the LNG so that the LNG expands in the heat exchanger.

2. A natural gas fuel supply system comprising:
a storage tank which contains LNG and BOG existing above the LNG and is equipped with a heat exchanger installed in an upper portion of an inside space of the storage tank;
a pump which is connected to a portion of the storage tank in order to discharge the LNG stored in the storage tank; and
a pressurizer which is connected to an outlet of the pump in order to increase pressure of the LNG transported by the pump.

3. The natural gas fuel supply system according to claim 2, wherein the heat exchanger includes:
an expansion valve into which the LNG, which is highly pressurized by a pressurizer, is introduced; and
a heat exchanger pipe which guides flow of the LNG so that the LNG expands in the heat exchanger.

4. A natural gas fuel supply system comprising:
a storage tank which contains LNG and BOG existing above the LNG and is equipped with a heat exchanger installed in an upper portion of an inside space of the storage tank; and
a pressurizer which is connected to an outlet of the storage tank in order to increase pressure of the LNG transported; wherein the heat exchanger includes:
an expansion valve into which the LNG, which is highly pressurized by the pressurizer, is introduced; and
a heat exchanger pipe which guides a flow of the LNG so that the LNG expands in the heat exchanger.

5. The natural gas fuel supply system according to claim 4, further comprising:
a pressure gauge installed on a pipe through which gasified LNG, which is generated during heat exchanging in the heat exchanger, flows; and
a control valve installed on a pipe near an outlet of the pressurizer, wherein
opening of the control valve is adjusted according to pressure measured by the pressure gauge.
